(19) United States
(12) Patent Application Publication
(10) Pub. No.: US 2004/0136055 A1
(43) Pub. Date: Jul. 15, 2004

(54) Automatic power control of a semiconductor optical amplifier

(75) Inventors: Walter Craig Michie, Killearn (GB); Stephen Conner, Glasgow (GB); Anthony Edward Kelly, Seam ill (GB)

Correspondence Address: SIERRA PATENT GROUP, LTD., P O BOX 6149, STATELINE, NV, 89449, US

(73) Assignee: Kamelian Limited, a United Kingdom Corporation

(21) Appl. No.: 10/601,073

(22) Filed: Jun. 19, 2003

(30) Foreign Application Priority Data
Jun. 19, 2002 (GB) 0214158.8

(51) Int. Cl. H01S 3/00; H04B 10/12

(52) U.S. Cl. 359/337.11

(57) ABSTRACT

An automatic power control system for automatic power control of a semiconductor optical amplifier arranged to amplify a signal has an automatic power control loop which provides automatic power control of the power of the amplified signal for maintaining the power of the amplified signal in the output from the semiconductor optical amplifier at a desired level. The automatic power control loop compensates for, an estimated level of amplified spontaneous emission in the detected output power using stored characteristics of the semiconductor optical amplifier. In one type of embodiment, a photodiode detects the output power of the semiconductor optical amplifier and a current detector detects the drive current of the semiconductor optical amplifier and the automatic power control loop uses both the detected output power of the semiconductor optical amplifier and the detected drive current. In another type of embodiment, the automatic power control loop uses only the detected output power of the semiconductor optical amplifier.

### PRIORITY CLAIMS

This application claims first priority of United Kingdom Patent Number GB 0214158.8 filed on Jun. 19, 2002.

### BACKGROUND

The present invention relates to automatic power control (APC) of a semiconductor optical amplifier (SOA). In use of a SOA to amplify an optical signal, automatic power control may be performed to maintain the output power of the signal amplified by the SOA at a desired level, even as the level of the input signal varies. Such APC is very important in many applications of an SOA, particularly in telecommunications systems where the power of the input signal can vary over a wide dynamic range, but it is desirable to provide an amplified signal at a constant level.

Conventional APC systems comprise an optical power detector arranged to detect the output power of the SOA, and an APC loop using the detected output power as a feedback signal to provide APC. Usually, APC is performed by varying the gain of the SOA.

Spontaneous emission occurring in the active material of the SOA is amplified and output from the SOA together with the amplified signal. The amplified spontaneous emission (ASE) increases the detected output power above the level of the amplified signal and therefore pushes the APC out of regulation, especially at low input signal strengths. As an example of this, FIG. 1 illustrates the fall-off in the output power of an amplified signal for a typical APC system as the input signal decreases. In particular, FIG. 1 is a graph of the output power of the amplified signal (Y-axis) in the total output power of the SOA against attenuation of an input signal (X-axis) for an APC system without any means to reduce the effect of ASE. As the power of the input signal is decreased (i.e. the attenuation is increased), the APC loop causes the gain to increase to maintain the total output power at a predetermined level. Such increase of the gain causes the ASE to increase. Thus the ASE forms a larger proportion of the total output power and the level of the amplified signal decreases as illustrated in FIG. 1. Since the ASE may be considered to be noise, this means that the signal-to-noise ratio decreases.

To deal with the problem of the ASE pushing the APC out of regulation, as the ASE is broadband, it has been suggested to provide the APC system with an optical band-pass filter centered on the frequency of the input signal to extract the input signal and reject most of the ASE which is broadband. The filtered output signal is supplied to the detector for use by the APC loop. To illustrate this, FIG. 2 is a graph for a typical SOA of the power of the output of the SOA against wavelength. The ASE is illustrated by the curve 1 and is broadband. The amplified signal provides a peak 2 within the narrow-band frequency channel, in this case around 1550 nm. The optical filter is provided with a characteristic approximately, as illustrated by the line 3 centered on the wavelength of the amplified signal. Accordingly, the optical filter extracts the amplified signal and removes most of the ASE, so the output of the power detector used by the APC loop is substantially the power of the amplified signal. As a result, the APC loop operates to maintain the power of the amplified signal at a desired level without being significantly affected by the ASE. An example of an APC system employing such an optical filter is disclosed in U.S. Pat. No. 5,854,704.

However, the use of such an optical filter is not entirely satisfactory. In particular, it significantly raises the costs and inconvenience of implementing, the APC system, particularly in telecommunications systems where it is desirable to provide SOAs for a plurality of different frequency channels.

For example, in a typical wave division multiplexing (WDM) optical network, there may be around 80 to 160 frequency channels. In general, to design an APC system which is suitable for each channel, it is possible either to use a different, fixed band-pass filter for each respective frequency channel, or to use a tunable band-pass filter which may be tuned to the respective channels. In the former case, although each individual fixed filter is relatively cheap, the need to provide an APC system with a different optical filter for each channel makes the total manufacturing cost high. It also creates inconvenience and high over-heads for the manufacturer in maintaining stocks of each filter and for the user in maintaining stocks of each SOA and APC system as spares for replacement purposes. Use of a tunable filter avoids these problems, but a tunable filter having a sufficiently narrow bandwidth combined with a sufficient tuning range would be very expensive and difficult to design and implement.

Therefore, it would desirable to provide APC in which the problems caused by ASE are reduced, but without the need to employ an optical filter which introduces the problems discussed above.

### BRIEF SUMMARY OF THE INVENTION

In accordance with a first aspect of the present invention, there is provided an automatic power control system for automatic power control of a semiconductor optical amplifier arranged to amplify a signal, the system comprising an optical power detector arranged to detect the output power of the semiconductor optical amplifier means for deriving a measure of the drive current of the semiconductor optical amplifier an automatic power control loop arranged to provide automatic power control of the power of the amplified signal for maintaining the power of the amplified signal in the output from the semiconductor optical amplifier at a desired level using both the detected output power of the semiconductor optical amplifier and the derived measure of the drive current.

According to the first aspect of the present invention, the APC loop uses both the detected output power and the derived measure of the drive current. This makes it possible for the APC loop to compensate accurately for an estimated level of ASE in the output power of the SOA. The compensation may be explicit in the sense that the estimated level of ASE is actually derived and used by the APC loop, or may be intrinsic in the algorithm implemented by the APC loop.

Such accurate compensation is based on an appreciation that the level of ASE can be accurately characterized by a knowledge of the drive current and either the output power or the level of the amplified signal in the output power. Therefore, based on information about these variables and taking account of the characteristics of the SOA, it is possible for the APC loop to compensate for the effects of the ASE on the APC. Furthermore, these benefits may be achieved without the use of a narrow optical band-pass filter to reject the ASE outside the frequency channel of the signal.

The output power of the SOA has contributions from both the amplified signal and the ASE. Therefore, by compensating for an estimated level of ASE, it is possible for the APC loop to maintain the power of the amplified signal at a desired level even as the level of the input signal and hence the ASE varies.

In some systems, the automatic power control loop may be arranged to compensate for an estimated level of amplified spontaneous emission in the output power of the semiconductor optical amplifier based on the derived measure of the drive current and the detected output power.

The level of ASE may be expressed as a function of both the drive current of the SOA, which controls the gain of the SOA, and the output power of the SOA. Therefore, it is possible for the APC loop to use information on these two variables to compensate for the estimated level of ASE in an accurate manner.

Alternatively, in other systems, the automatic power control loop is arranged to compensate for an estimated level of amplified spontaneous emission in the output power of the semiconductor optical amplifier based on the derived measure of the drive current and the desired level of the amplified signal.

As the output power is equal to the sum of the power of the amplified signal plus the power of the ASE, the level of ASE may also be expressed as a function of both the drive current and the amplified signal. Although the power of the amplified signal is not measured directly, when the APC loop is locked, the amplified signal is maintained at the desired level. This means it is possible to use the desired level, together with the derived measure of the drive current, to perform the-compensation for an estimated level of ASE. Of course, as the APC loop is operated to provide APC, the actual level of the amplified signal may drift slightly from the desired level until the APC loop operates to bring the amplified signal back to the desired level. However, such variations are relatively small and short-lived, so do not affect the compensation for an estimate level of ASE when using the desired level of the amplified signal.

Therefore, in general, particular advantage is achieved by compensating for an estimated level of amplified spontaneous emission in the output power of the semiconductor optical amplifier using at least the derived measure of the drive current.

According to a second aspect of the present invention there is provided, an automatic power control system for automatic power control of a semiconductor optical amplifier arranged to amplify a signal, the system comprising an optical power detector arranged to detect the output power of the semiconductor optical amplifier an automatic power control loop arranged to provide automatic power control of the power of the amplified signal for maintaining the power of the amplified signal in the output from the semiconductor optical amplifier at a variable, desired level using the detected output power of the semiconductor optical amplifier, wherein the automatic power control loop is arranged to compensate for an estimated level of amplified spontaneous emission in the output power of the semiconductor optical amplifier based on at least two variables.

The second aspect of the present invention involves the APC loop compensating for an estimated level of ASE in the output power of the SOA. This is based on an appreciation that the level of ASE can be characterized accurately by a knowledge of at least two variables.

In many implementations, one of the variables is the detected output power. This is convenient as the output power is generally used as the feedback parameter used by the APC loop.

The other variable may be the drive current, which may be detected or may be derived from the output of the APC loop because this controls the drive current. Alternatively, the other variable may be the desired level of the amplified signal in the output power.

In general variables such as the detected output power, the drive current and the desired level of the amplified signal are interrelated mathematically, so in principle any two variables could be used.

Therefore, based on information about two variables and taking account of the characteristics of the SOA, it is possible for the APC loop to compensate for the effects of ASE on the APC. Furthermore, these benefits may be achieved without the use of a narrow optical band-pass filter to reject the ASE outside the frequency channel of the signal.

The output power of the SOA has contributions from both the amplified signal and the ASE. Therefore, by compensating for an estimated level of ASE, it is possible for the APC loop to maintain the power of the amplified signal at a desired level, even as the level of the input signal and hence the ASE varies.

Advantageous features of both aspects of the present invention are as follows.

In some systems, the automatic power control loop is arranged to compensate for an estimated level of amplified spontaneous emission in the output power of the SOA based on the detected output power and a measure of the drive current.

The level of ASE may be expressed as a function of both the output power of the SOA and the drive current of the SOA which controls the gain of the SOA. Therefore, it is possible for the APC loop to use information on these two variables to compensate for an estimated level of ASE.

In some other systems, the automatic power control loop is arranged to compensate for an estimated level of amplified spontaneous emission in the output power of the semiconductor optical amplifier based on the detected output power and the desired level of the amplified signal.

As the output power is equal to the sum of the power of the amplified signal plus the power of the ASE, the level of ASE may also be expressed as a function of the output power and the level of the amplified signal. Although the power of the amplified signal is not measured directly, when the APC loop is locked, the amplified signal is maintained at the desired level. This means it is possible to use the desired level, together with the detected output power, to perform the compensation for an estimated level of ASE. Of course, as the APC loop is operated to provide APC, the actual level of the amplified signal may drift slightly from the desired level until the APC loop operates to bring the amplified signal back to the desired level. However, such variations are relatively small and short-lived, so do not effect the compensation significantly when using the desired level of the amplified signal.

Desirably, the automatic power control loop further comprises memory means storing characteristics of the semiconductor optical amplifier, the automatic power control loop using the stored characteristics to compensate for the estimated level of amplified spontaneous emission in the output power of the semiconductor optical amplifier.

In general, different SOAs have different characteristics. Whilst it would be possible to provide some degree of compensation for ASE using typical characteristics, it is preferable for the APC loop to store characteristics of the SOA, because this makes it possible to adapt the compensation to the characteristics of the particular SOA being controlled.

The characteristics may be easily measured for a given SOA. It is normal to perform some form of characterisation of an SOA after manufacture, for example by characterizing the output power over the entire operational range of input signals and drive currents. Since such characterisation is being performed anyway, there is minimal extra work and equipment involved in additionally measuring characteristics needed for compensation of ASE. For example, the stored characteristics may be the level of ASE as a function of the drive current and of either the detected output power or the level of the amplified signal. Since the detected output power is equal to the sum of the level of the amplified signal and the power of the ASE, other characteristics may equally be stored, such as the level of the amplified signal as a function of the drive current and the detected output power.

The characteristics may be stored in any convenient manner. The characteristics may be stored in a look-up table which is particularly easy to implement. A look-up table has a high memory requirement if it is to store data points at sufficient resolution to use the stored data directly. To reduce the amount of data to be stored, the look-up table may be stored at a coarse resolution and the characteristics may be retrieved using a bilinear interpolation algorithm. In this way it is possible to increase the resolution to the desired level whilst minimizing memory requirements. Alternatively, a numerical formula representing the characteristics may be stored.

Desirably, the automatic power control loop is arranged to derive an estimated level of the amplified signal from the detected output power, compensating for the level of amplified spontaneous emission in the output power of the semiconductor optical amplifier, and to provide said automatic power control using the estimated level of the amplified signal.

Arranging the APC loop to derive an estimated level of the amplified signal from the detected output power is a convenient method of compensating for the level of ASE. In particular, it has the benefit of implementing the compensation in a direct, intuitive manner. However, in general, the APC loop may be arranged in many different ways to compensate for ASE either directly or intrinsically in the control algorithm employed.

Advantageously, the automatic power control loop is arranged to derive the error between the estimated level of the amplified signal and the desired level of the amplified signal, and to provide said automatic power control using said error. This allows the control of the power to be implemented in a conventional manner, because APC loops are normally error-controlled.

In general, the APC loop may be implemented by analog or digital circuitry, or by a combination thereof.

In one preferred type of APC loop, the automatic power control loop comprises an analog feedback loop arranged to perform power control of the semiconductor optical amplifier using the detected output power as a feedback signal to maintain the output power of the semiconductor optical amplifier at a selectable level; and a controller arranged to control said selectable level compensating for an estimated level of amplified spontaneous emission using at least the derived measure of the drive current so that the power of the amplified signal is maintained at the desired level by the analog feedback loop.

This type of APC loop uses an analog loop to perform the power control using the detected output power as a feedback signal. Consequently, this part of the APC loop may take the form of a conventional APC analog feedback loop. The use of such an analog feedback loop has the advantage of providing a fast transient response. However, the analog feedback loop does not itself compensate for the level of ASE in the output power, which function is performed by a separate controller. In particular, the controller compensates for the level of ASE in controlling the selectable level so that the power of the amplified signal is maintained at the desired level by the analog feedback loop. In this type of embodiment, the controller is advantageously a digital controller, such as a digital signal processor. By using the controller in combination with the analog feedback loop, the controller can be relatively simple because the algorithm it implements is straightforward.

The use of an analog feedback loop in combination with a separate feedback to the controller brings the potential risk of instability, although this can be avoided by careful design, for example by ensuring the transient response of the controller is slower than the transient response of the analogue feedback loop.

In a second type and a third type of embodiment which avoids the risk of instability, the APC-loop the automatic power control loop comprises a digital controller arranged to provide said automatic power control of the semiconductor optical amplifier. In the second type of embodiment, the digital controller uses both the detected output power and the derived measure of the drive current. In the third type of embodiment, the digital controller uses both the detected output power and the desired level of the amplified signal.

By using a digital controller to provide the automatic power control using both the detected output and the derived measure of the drive current is convenient and easy to implement a stable response without any instability. On the other hand, it has the disadvantage that the controller must have a higher speed than is necessary for the controller of the first type of embodiment.

The optical power detector for detecting the output power of the semiconductor amplifier may take any suitable form. For example, it may be an optical photodetector arranged externally of the SOA or integrated with the SOA, either monolithically in the same semiconductor chip as the SOA or in a hybrid package together with the SOA.

Advantageously, the means for detecting a measure of the drive current of the semiconductor optical amplifier is a current detector. Use of a current detector is convenient, because it provides a direct measure of the drive current. However, in principle a measure of the drive current could be obtained in any other convenient way. For example, when the APC loop forms power control by controlling the drive current, the measure of the drive current can be obtained indirectly from within the APC loop, for example by the controller.

Advantageously, the controller further comprises means for outputting monitor signals representing at least one of the detected output power; the estimated level of the amplified signal; or the estimated level of the amplified spontaneous emission in the output power.

Such monitor signals are easily derived by the controller, because such signals are directly or indirectly produced by the control algorithm of the APC loop in compensating for the estimated level of ASE. Therefore, by arranging the controller to output such monitor signals, the APC loop may additionally be used to monitor the communications channel. This ability to monitor the communication channel provides a significant advantage for the present invention. Typically monitoring of a frequency channel is performed by use of a separate monitor arranged in the optical path, the cost of which can be avoided by the APC loop of the present invention outputting such monitor signals. As SOAs are commonly dispersed throughout a telecommunications network, this allows monitoring at many points within the network. This has advantages in many applications, but in particular in a reconfigurable optical add-drop multiplexer in which separate SOAs are arranged in each frequency channel. By using the APC system of each SOA, it is possible to monitor every channel at minimal extra cost. In contrast, a channel monitor for monitoring a plurality of channels as an additional component would be very expensive.

In accordance with further aspects of the present invention, there are provided corresponding methods of performing automatic power control.

### BRIEF DESCRIPTION OF THE DRAWINGS

In the drawings:

FIG. 1 is a graph of the fall-off of the output power when APC is performed without ASE compensation;

FIG. 2 is a graph of the optical power of the output of an SOA against wavelength illustrating the ASE and the amplified signal;

FIG. 3 is a three dimensional view of the characteristics of the SOA;

FIG. 4 is a schematic diagram of a first measuring circuit which may be used to characterize an SOA after manufacture;

FIG. 5 is a schematic diagram of a second alternative measuring circuit which may be used to characterise an SOA;

FIG. 6 is a diagram of a first APC system, of a type employing an analog feedback loop and a digital controller;

FIG. 7 is a diagram representing the algorithm implemented by the controller of the APC system of FIG. 6;

FIG. 8 is a diagram of a second APC system, of a type employing a digital controller;

FIG. 9 is a diagram representing the control algorithm implemented by the digital controller of the APC system of FIG. 8;

FIG. 10 is a diagram of a third APC system, of a type employing a digital controller;

FIG. 11 is a diagram representing a first control algorithm implemented by the digital controller of FIG. 10;

FIG. 12 is a diagram representing a second, alternative control algorithm implemented by the digital controller of FIG. 10; and

FIG. 13 is a diagram of a reconfigurable optical add-drop multiplexer.

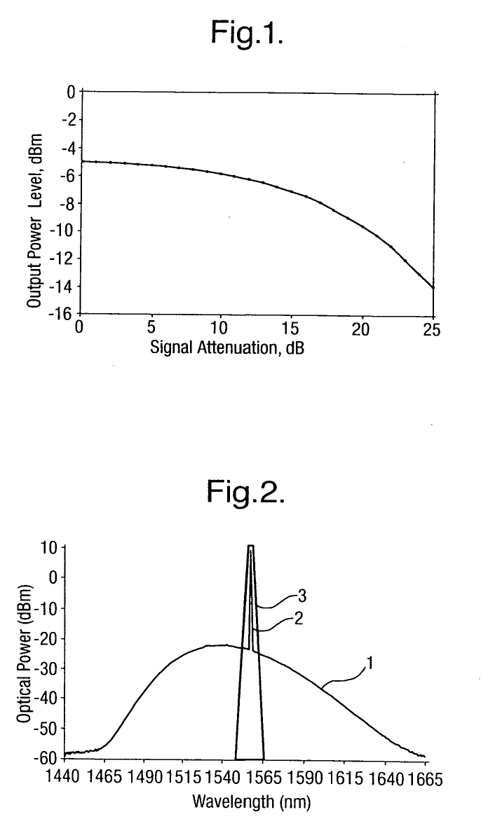

### DETAILED DESCRIPTION OF THE INVENTION

To allow better understanding, embodiments of the present invention will now be described by way of non-limitative example with reference to the accompanying drawings.

An APC system in accordance with the present invention may be used to control any known form of SOA for amplifying an optical signal. Such SOAs are generally produced for use within telecommunications networks. A typical SOA is described in WO-961405. The SOA may be fabricated from materials such as in GaAsP. The SOA will be designed with a gain centered around a desired signal band, typically a particular communications wavelength band (e.g. 1.55 μm). Typically, the SOA consists of an elongate amplification region of active material formed on a substrate, the SOA forming a waveguide along the active material. The waveguide has an input and an output preferably formed with anti-reflection coatings, or otherwise, such that the reflection experienced at the input and output is very low.

The present invention takes advantage of the fact that the level of ASE in the output power of the SOA, and thus the level of the amplified signal in the output power, may be characterized as a function of the drive current supplied to the SOA and of the detected output power.

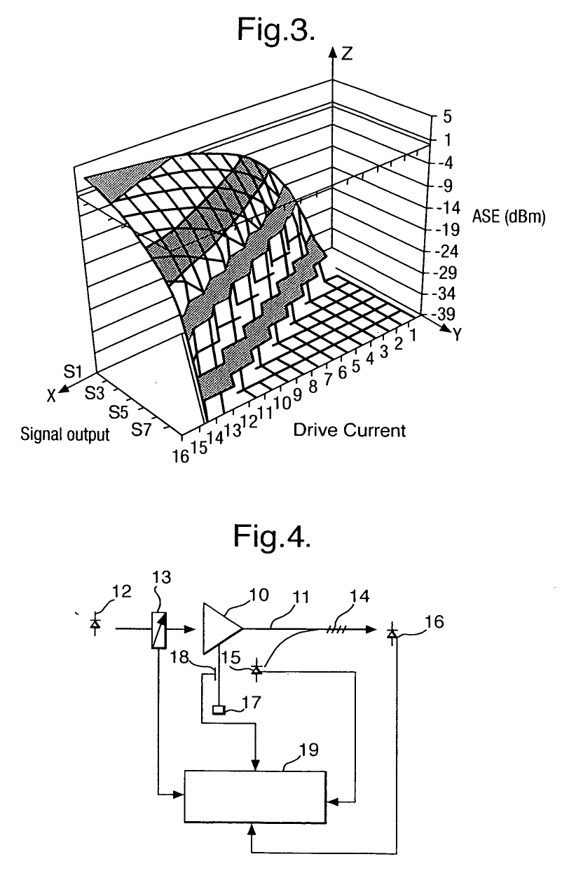

To illustrate this, FIG. 3 shows the characteristics of a typical SOA. In particular, FIG. 3 is a three dimensional view of a graph of the level of ASE (Z-axis) in the output power, as a function of the drive current (X-axis) of the SOA and of the level of the amplified signal (Y-axis). As can be seen from FIG. 3, the amount of ASE varies with both the drive current of the SOA and with the level of the amplified signal.

Given that the output power of the SOA is equal to the sum of the power of the amplified signal plus the power of the ASE, by a simple change of coordinates, the characteristics of the SOA could equally be represented by other variables. For example, the characteristics could be represented by the level of the amplified signal as a function of the drive current and the detected output power. As the characteristics have two degrees of freedom, in general it is possible to estimate the level of ASE, or alternatively the level of the amplified signal based on a knowledge of two variables, for example the drive current and total output power of the SOA, or the drive current and the level of the amplified signal.

The present invention takes advantage of such knowledge of the characteristics of the SOA to provide automatic power control to maintain the power of the amplified signal at a desired level, compensating for an estimated level of ASE in the detected output power.

The embodiments of the present invention store and use the characteristics of the SOA, as will be described in more detail below. To derive the information for storage, the characteristics are measured after the SOA has been manufactured. This does not involve significant extra effort, because it is normal to measure at least some of the characteristics of an SOA after manufacture across the normal operating range of input signals and drive currents. Therefore, additionally measuring characteristics for use by the APC system of the present invention involves little extra effort or equipment.

FIG. 4 schematically illustrates a first measurement circuit suitable for measuring the characteristics of an SOA 10. The measurement circuit comprises an optical path 11 into which the SOA 10 is inserted. The optical path 11 receives light from a laser source 12 having a fixed output power. A variable attenuator 13 is arranged in the signal path 11 between the laser source 12 and the SOA 10 to vary the power of the signal input to the SOA 10. The laser source 12 is arranged to output a signal in the signal band in which it is desired to use the SOA 10.

On the output side of the SOA 10, the signal path 11 is provided with a fiber Bragg grating 14 which is arranged to reflect light within the signal band whilst passing light of other wavelengths. The light reflected by the fiber Bragg grating 14 is therefore the amplified signal and is detected by a signal photodiode 15 coupled into the signal path 11 between the SOA 10 and the fiber Bragg grating 14. Conversely, the light passed by the fiber Bragg grating 14 is the ASE outside the signal band and is detected by an ASE photodiode 16 arranged at the output of the signal path 11. Of course, the power of the ASE within the signal band is reflected by the fiber Bragg grating 14 and so contributes to the power detected by the signal photodiode 15, not the ASE detector 16. However, as the ASE is broadband, the amount of ASE within the signal band is relatively small and does not significantly affect the measurement of the signal by the signal photodiode 15 or the measurement of the ASE by the ASE photodiode 16.

The SOA 10 is supplied with a drive current from a variable current source 17. The drive current is detected by a detector 18. The measurement circuit comprises a PC 19 running a program to operate as a data logger. The PC 19 is supplied with the attenuation setting of the variable attenuator 13 which corresponds to the power of the input signal supplied to the SOA 10. The PC 19 is also supplied with the outputs of the signal photodiode 15, the ASE photodiode 16 and the current detector 18. In use, the input signal is varied over the normal operating dynamic range by varying the setting of the attenuator 13 and the drive current is similarly varied by the current source 17 over the normal operating range. The PC 19 records the characteristics of the SOA over this operating range. The characteristics may be represented in any of the forms discussed above.

The characteristics recorded by the PC 19 are subsequently stored in the APC systems of the present invention described in more detail below. The characteristics may be stored in any appropriate form, for example as a function of the drive current and of the detected output power, or as a function of the drive current and the level of the amplified signal. The characteristics may be stored as a look-up table. Such a look-up table is particularly easy to implement, because it may simply store the data recorded by the PC 19. However, a look-up table requires a high memory capacity if it is to store data at a sufficient resolution to allow the stored data to be used directly. Therefore, it is preferred to provide means for extracting the data from the stored table using a bilinear interpolation algorithm to increase the resolution. This provides the advantage of allowing the data to be stored at a coarser resolution thereby decreasing the memory requirement. Significant savings can be achieved. For example in one embodiment, a 32×32 look-up table is stored and the interpolation is performed in 32 substeps in each dimension. This gives a resolution equivalent to a 1024×10²⁴ uninterrupted look-up table, operating at a precision of 1 part in 1024, but only uses 1K words of memory. Alternatively, the characteristics may be stored as a numerical formula. This would reduce the amount of stored data as compared a look-up table with sufficient resolution to be used directly. However, the amount of data would preferably be similar to that of a look-up table to be used with interpolation, and so it is not preferred in view of the complexity of programming such a formula.

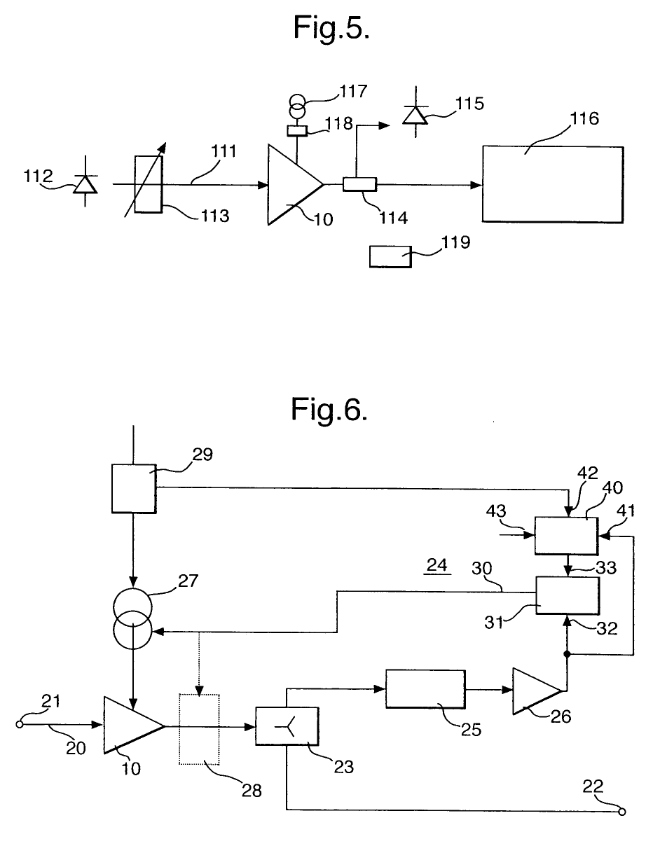

FIG. 5 schematically illustrates a second, alternative measurement circuit for measuring the characteristics of the SOA 10. The measurement circuit comprises an optical path 111 into which the SOA 10 is inserted. The optical path 111 receives light from a laser source 112 having a fixed output power. A variable attenuator 113 is arranged in the signal path 111 between the laser source 112 and the SOA 10 to vary the power of the signal input to the SOA 10.

On the output side of the SOA 10, a tap-coupler 114 is arranged in the signal path 11I to extract a predetermined proportion of the output power of the SOA 10, typically 1%, and supply the extracted power to a photo-diode 115 which therefore detects the total output power of the SOA 10 including both the amplified signal and the ASE. The remaining output power of the SOA 10 not extracted by the tap-coupler 114 is supplied to an optical spectrum analyzer 116 which is used to record both the power of the amplified signal and the ASE power. As in the measurement circuit of FIG. 4, the drive current to the SOA 10 is supplied from a variable current source 17 having a detector 118 in series to detect the drive current. The outputs of the photo-diode 116, the optical spectrum analyzer 116 and the current detector 118 are supplied to a PC 119 running a program to operate as a data logger. The PC 119 is also supplied with the attenuation setting of the variable attenuator 113 which corresponds to the power of the input signal supplied to the SOA 10.

In use, the signal input to the SOA 10 is varied over the normal operating dynamic range by varying the setting of the attenuator 113 and the drive current is, similarly varied by the current source 117 over the normal operating range. The PC 119 records the characteristics of the SOA 10 over this operating range in the same manner as for the measurement circuit of FIG. 4, as described above.

FIG. 6 illustrates a first APC system for the SOA 10. The SOA 10 is arranged in an optical path 20 between an input 21 and an output 22. The input 21 receives an input signal in a given signal band. The SOA 10 amplifies the input signal. The output of the SOA 10 is the amplified signal in the signal band, together with ASE which is broadband. Therefore, the output of the SOA 10 has a similar form to that illustrated in FIG. 2.

In the signal path 20 on the output side of the SOA 10, a tap-coupler 23 or other splitter is arranged to extract a predetermined proportion of the power of the output of the SOA 10, typically 1%, for use by an APC loop 24. The remainder of the output of the SOA 10 is passed by the tap-coupler 23 to the output 22. The proportion of the output of the SOA 10 extracted by the tap-coupler 23 is supplied to a photodiode 25 which acts as an optical power detector to detect the output power of the SOA 10.

The detected output power detected by the photodiode 25 is passed through an amplifier 26 to the APC loop 24. The amplifier 26, as well as providing amplification, also has the effect of low-pass filtering the detected output power detected by the photodiode 25, so that the detected output power used by the APC loop 24 is time-averaged over a period longer than the data period. In general, any means for performing such time-averaging may be provided.

The SOA 10 is supplied with a drive current by a variable current source 27. The drive current controls the gain of the SOA 10. The APC loop 24 controls the current source 27 to vary the drive current and hence the gain of the SOA 10. In this way, the APC loop 24 controls the power of the amplified signal amplified by the SOA 10 and thereby performs automatic power control.

Controlling the drive current to the SOA 10 is the conventional way to provide the automatic power control of the power of the amplified signal, but other ways of providing power control are equally possible. For example, as an alternative to the APC loop 24 controlling the current source 27, a variable optical attenuator 28 or any device providing variable optical attenuation, may be provided in the optical path 20, usually on the output side of the SOA 10. In this case, the APC loop 24 may be arranged to control the attenuation of the attenuator 28, thereby to control the power of the amplified signal output from the combination of the SOA 10 and the attenuator 28. The attenuator 28 is shown in dotted outline in FIG. 6 to indicate that it is an optional alternative.

Arranged in series with the current source 27 is a current detector 29 which detects the drive current supplied to the SOA 10. The detected drive current is supplied to the APC loop 24.

The APC loop 24 will now be described.

The APC loop 24 comprises an analog feedback loop 30 which receives the output power detected by the photodiode 25 as a feedback signal. The analog feedback loop 31 performs power control of the SOA 10 by controlling the current source 27. In particular, the analog feedback-loop 30 comprises a driver circuit 31 which receives the detected output power detected by the photodiode 25 as a first input 32 and receives a selectable set point level as a second input 33. The driver circuit 31 controls the current source 27 based on the error between the first and second inputs 32 and 33 to maintain the detected output power at the set point level.

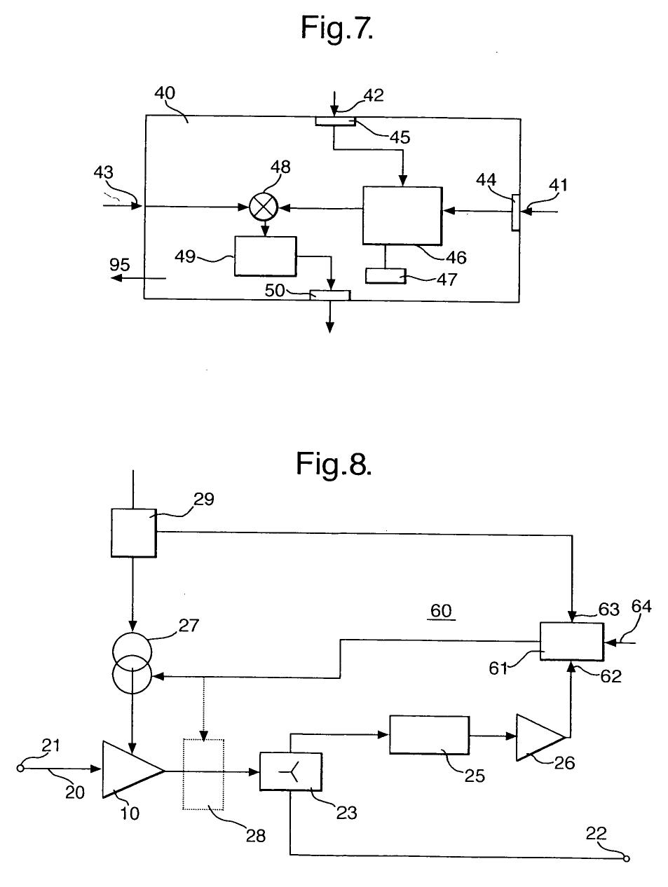

The APC loop 24 further comprises a controller 40 which controls the set point level supplied as the second input 33 to the driver circuit 31. The controller 40 receives and uses: (i) the detected output power detected by the photodiode 25, as a first input 41, (ii) the detected drive current detected by current detector 29, as a second input 42, and (iii) a third input 43 representing the desired level of the amplified signal in the output power of the SOA 10. The controller 40 is digital and is arranged to implement a control algorithm illustrated in FIG. 7. The controller 40 may be any suitable digital circuit, for example a digital signal processor. Whilst the control algorithm is illustrated in FIG. 7 by functional blocks for ease of understanding, the controller 40 may implement the algorithm using hardware, software or any combination thereof.

The controller 40 has a first A/D converter 44 to convert the detected output power supplied at the first input 41 to a digital signal. The controller 40 further has a second A/D converter 45 to convert the detected drive current supplied to input 42 into a digital signal.

The detected drive current and the output power are used by an estimator 46 to derive an estimate of the level of the amplified signal in the output power. The estimator 46 uses the characteristics of the SOA 10 stored in a memory 47 in the controller 40, as discussed above.

The estimated level of the amplified signal from estimator 46 and the desired level of the amplified signal input from input 43 are supplied to a subtractor 48 which calculates the error therebetween. The error calculated by subtractor 48 is supplied to a control algorithm 49 which uses the error to derive the set point level for the SOA driver circuit 31 of the analog feedback loop 30. The derived set point level is output from the controller 40 through a D/A converter to provide the SOA driver circuit 31 with an analog signal.

In the controller 40, the estimator 46, in estimating the level of the amplified signal, compensates for an estimated level of ASE in the output power of the SOA 10 using the characteristics stored in the memory 47.

The control algorithm implemented by the controller 40 can be varied in many ways whilst still providing such compensation. For example, instead of using the detected output power, the estimator 46 could use the set point level output by the control algorithm 49 as a measure of the output power. Since the analog feedback loop 30 controls the output power of the SOA 10 to maintain the output power at the selectable set point level derived by the controller 40, the set point level provides a sufficiently accurate measure of the detected output power for use by the estimator 46. The variations of the actual output power of the SOA 10 from the set point level are sufficiently small and short-lived as not to affect the proper operation of the estimator 46.

The first APC system of FIG. 6 has the advantage that the analog feedback loop 30 has a fast transient response. The analog feedback loop responds quickly to changes in the power of the signal input to the SOA 10. Thus a rough correction is provided immediately. It is preferred that the digital controller 40 has a slower transient response than the analog feedback loop 30 to prevent any problems of instability. Therefore, when the power of the input signal input to the SOA 10 changes, the fast correction provided by the analog feedback loop 30 is not immediately compensated for the ASE. A more exact ASE compensation is performed more slowly as the controller 40 responds to the changes in drive current and output power of the SOA 10.

The arrangement of the APC system of FIG. 6 with a separate analog feedback loop 30 and digital controller 40 also provides the advantage that the digital controller 40 can be of relatively low speed thereby simplifying the controller 40 and providing a relatively low cost.

A second APC system is illustrated in FIG. 8. The second APC system of FIG. 8 has an APC control loop 60 which differs from the APC control loop 24 of the system of FIG. 6. Otherwise, the APC system of FIG. 8 is identical to the APC system of FIG. 6, so for brevity the common elements are given the same reference numerals and a description thereof will not be repeated.

In the APC system of FIG. 8, the APC control loop 60 comprises a controller 61 which implements the entire control algorithm digitally and which itself controls the current source 27 to provide power control of the SOA 10. As for the first APC system of FIG. 6, the power control could equally be performed in other ways.

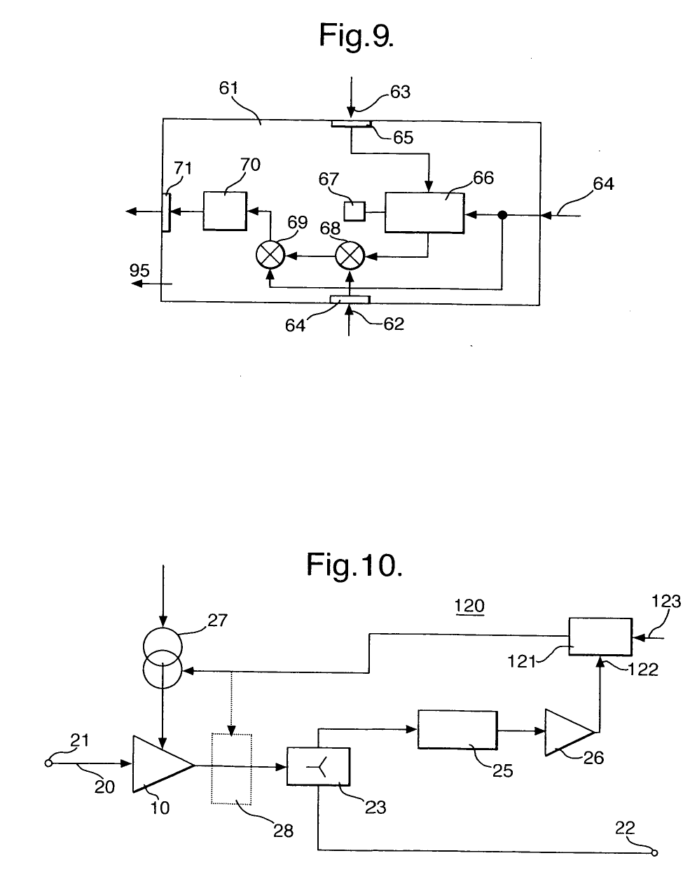

The controller 61 may be any suitable digital circuit, for example a digital signal processor. The control algorithm implemented by the controller 61 is illustrated in FIG. 9. Although FIG. 9 illustrates the control algorithm by functional blocks for simplicity of description, the control algorithm may be implemented by hardware, software or a combination thereof.

The controller 61 receives and uses: (i) as a first input 62, the detected output power output from the photodiode 25; (ii) as a second input 63, the detected drive current output by the current detector 29; and (iii) as a third input 64, the desired level of the amplified signal. The controller 61 has a first A/D converter 64 for converting the detected output power input at input 62 into a digital signal, and a second A/D converter 65 for converting the detected drive current received at input 63 into a digital signal.

The controller 61 has an estimator 66 which uses the detected drive current and the desired level of the amplified signal to derive an estimate of the level of the ASE in the output power of the SOA. The estimator 66 derives this estimate using the characteristics of the SOA 10 stored in a memory 67, as discussed above.

The controller 61 further comprises a first subtractor 68 to subtract the estimated level of ASE estimated by the estimator 66 from the detected output power supplied to input 62. Therefore, the output of the first subtractor 68 is an estimate of the level of the amplified signal in the output power of the detector. This estimated level of the amplified signal is supplied to a second subtractor 69, together with the desired level of the amplified signal supplied to input 64. The second subtractor 69 calculates the error between the estimated level of the amplified signal provided by the first subtractor 68 and the desired level of the amplified signal. The error output by the second subtractor 69 is supplied to a control algorithm 70 which derives a signal for controlling the current source 27. The control signal 70 is output through a D/A converter 71 to convert the control signal into an analog signal.

Therefore, in the controller 61, the estimator 66 and the first subtractor 68 together derive an estimate of the level of the amplified signal compensating for an estimated of the level of ASE.

The control algorithm implemented by the controller 61 may be varied in many ways. For example, the estimator 66 may use the detected output power input to input 62, instead of the desired level of the amplified signal input to input 64. In this case, the first subtractor 68 could be omitted by modifying the estimator 66 to directly output an estimate of the level of the amplified signal in the output power of the SOA 10.

It will be noted that the estimator 66 uses the desired level of the amplified signal 66 to estimate the level of ASE, for which the controller 61 compensates by way of the first substracter 68 subtracting that estimated level of ASE from the detected output power. Since the APC loop 60 operates to maintain the power of the amplified signal at the desired level, the use of the desired level by the estimator 66 derives a proper estimate of the level of ASE. Although there can be slight variations between the desired and actual levels of the amplified signal, the operation of the APC loop 60 ensures that such variations are small and short-lived, so the compensation for ASE still is performed correctly.

In the second APC system of FIG. 8, the use of a digital controller 61 avoids any problem with instability which could potentially be caused in the APC system of FIG. 6 by the use of a digital controller 40 controlling an analog feedback loop 30. However, the digital controller 61 must be of relatively high speed, as compared to the digital controller 40 of the APC system of FIG. 6.

Both the APC loop 24 of the first system of FIG. 6 and the APC loop 60 of the second system of FIG. 8 use the detected drive current output by the detector 29 as a measure of the drive current to perform compensation for ASE. As, an alternative, since the APC loop 24 and the APC loop 60 effectively control the drive current, it would alternatively be possible to derive a measure of the drive current indirectly within the APC loop 24 or the APC loop 60, instead of using the detected drive current.

A third APC system is illustrated in FIG. 10. The APC system of FIG. 10 is the same as the second APC system of FIG. 8, except for the current detector 29 being omitted and for having an APC control loop 120 which differs from the APC control loop 60 of the, system of FIG. 8. Otherwise, the APC system of FIG. 10 is identical to the APC system of FIG. 8, so for brevity the common elements are given the same reference numerals and a description thereof will not be repeated.

In the third APC system of FIG. 10, the APC, control loop 120 comprises a controller 121 which implements the entire control algorithm digitally and which itself controls the current source 27 to provide power control of the SOA 10. As for the APC systems described above, the power control could equally be performed in other ways.

The controller 121 supplies a control signal to the current source 27 representative of the desired drive current, that is representing the absolute level of the drive current, rather than being an error signal as in the second APC system of FIG. 8.

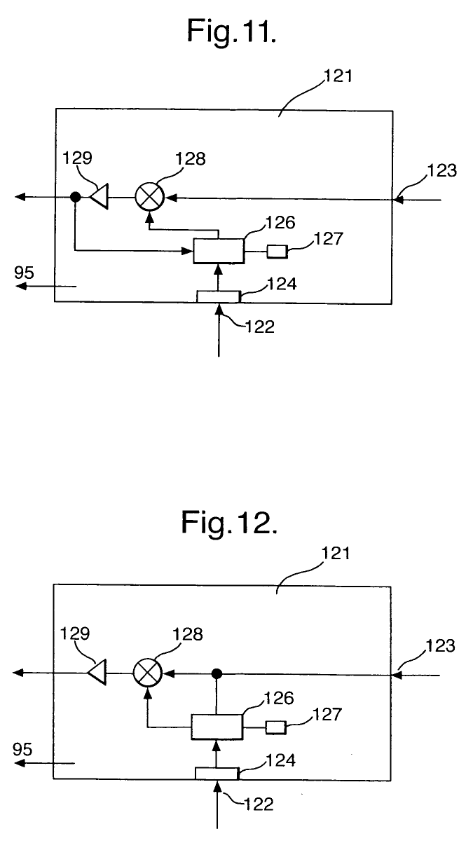

The controller 121 may be any suitable digital circuit, for example a digital signal processor. Two alternative control algorithms implemented by the controller 121 are illustrated in FIGS. 11 and 12, respectively. Although FIGS. 11 and 12 illustrated the control algorithm by functional boxes for simplicity of description, the control algorithm may be implemented by hardware, software or a combination thereof.

The first control algorithm illustrated in FIG. 11 will now be described.

The controller 121 receives and uses: (i) as a first input 122, the detected output power from the photo-diode 25; and (ii) as a second input 123, the desired level of the amplified signal. The controller 121 has an A/D converter 124 for converting the detected output power input at input 122 to additional signal.

The controller 121 has an estimator 126 which derives an estimate of the power of the amplified signal in the output power of the SOA using the detected output power and the control signal output by the controller 121 to control the current source 27. The estimator 126 derives this estimate using the characteristics of the SOA 10 stored in a memory 127, as discussed above.

The controller 121 further comprises a subtractor 128 to calculate the error between the estimated power of the amplified signal estimated by the estimator 126 and the desired level of the amplified signal input at input 123. The error output by the subtractor 128 is supplied to a control algorithm 129, which may be in the form of an integrator, or alternatively a PID (proportional-integral-derivative) controller. The output of the control algorithm 129 is the absolute level of the desired drive current and is output from the controller 121 as the control signal to the current source 27.

In operation, as the controller approaches the steady state condition, when the drive current is near the correct value, the estimated power output by the estimator 126 nears the desired power input at input 123 and hence the error signal output by the subtractor 128 approaches zero. Thus, the control algorithm 129 must be provided with sufficient integral gain to maintain the bias current at the correct value with a near zero input signal.

The alternative control algorithm illustrated in FIG. 12 is the same as the first control algorithm implemented in FIG. 11, except that instead of the output control signal being supplied to the estimator 126, the desired level of the amplified signal input at input 123 is supplied to the estimator 126. Therefore, the estimator 126 uses the detected output power input at input 122 and the desired level of the amplified signal from input 123. Since the APC loop 120 operates to maintain the power of the amplified signal at the desired level, the use of the desired level by the estimator 126 derives a proper estimate of the signal power, compensating for the level of ASE. Although there can be slight variations between the desired and actual levels of the amplified signal, the operation of the APC loop 120 ensures that such variations are small and short-lived so the compensation for ASE is still performed correctly.

In the third embodiment of FIG. 10, the current to the SOA 10 is operated outside the APC control loop. Therefore, the current source 27 may have, integrated within it, a control loop that controls the drive current based on the error between the control signal supplied to the current source 27, from the APC control loop 120 and a measure of the drive current. Alternatively, such a control loop may be arranged externally of the current source 27, for example including a current detector to measure the drive current and an error controller to derive the error between the drive current and the control signal from the APC control loop 120.

A particular advantage of the APC system is that it may easily be modified to output monitor signals. In particular, it will be noted that both the controller 40 in the first APC system of FIG. 6, the controller 61 in the second APC system of FIG. 8 and the controller 121 in the third APC system receive the detected output power and calculate at least one of the estimated level of the amplified signal and the estimated level of ASE in the output power. The controller 40 in the first APC system does not calculate the estimated level of the ASE, but could equally be modified to do so by subtracting the estimated level of the amplified signal from the detected output power. Therefore, the controller 40 can optionally be arranged to output monitor signals 95 representing one or more of: the detected output power; the estimated level of the amplified signal; or the estimated level of the ASE in the output power. Such monitor signals 95 may be applied to a display for displaying the values, or may be used by further circuitry.

The ability to generate such monitor signals 95 with a minimal modification to the APC system is very useful, because it allows the communications channel in which the SOA 10 is arranged to be monitored at low cost without the need to provide additional monitoring circuitry. This aspect is of particular advantage because it allows monitoring at every position along a channel where an SOA is provided, SOAs being frequently used throughout an optical network.

APC systems in accordance with the present invention may be used to advantage in any application where an SOA is provided. The APC system is of particular advantage when used in a receiver, in a reconfigurable optical add-drop multiplexers (ROADM) or with SOAs used for gain equalization.

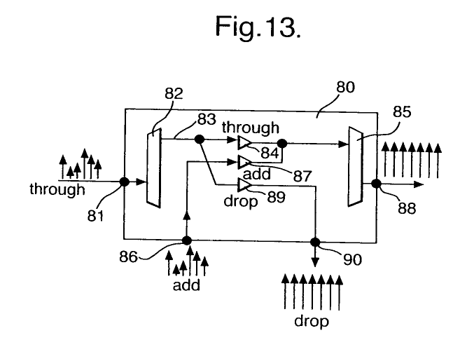

A ROADM 80 to which the APC system is is illustrated in FIG. 13.

The ROADM 80 has a through channel input 81 arranged to receive a multiplexed through channel signal comprising a plurality of respective through channel signals each in a respective frequency band, multiplexed together. The input multiplexed signal is supplied to a demultiplexer 82 which demultiplexes the individual through channel signals and outputs each to a respective frequency, channel 83. In FIG. 9, the components of only, a single frequency channel 83 are illustrated for clarity, but each frequency channel 83 has the identical components.

Each demultiplexed through channel signal in a respective frequency channel 83 is supplied to a through channel SOA 84 which amplifies the through channel signal and supplies the output to a multiplexer 85.

For each frequency channel 83, the ROADM 80 comprises an input 86 for receiving an add channel signal in the respective frequency based. Also, in respect of each frequency channel 83, the ROADM 80 comprises an add channel SOA 87 which amplifies the add channel signal and the respective frequency channel and supplies the output to the multiplexer 85.

The multiplexer 85 is arranged to multiplex together the outputs of all the through channel SOAs 84 in respect of each frequency channel 83 and the outputs of all the add channel SOAs 87 in respect of each frequency channel 83, to form an output signal which is supplied to a through channel output 88.

In addition, in respect of each frequency channel 83, the ROADM 80 has a drop channel SOA 89, arranged to amplify the demultiplexed through channel signal output from the demultiplexer 82. The signals output by the drop channel SOAs 89 are output at respective outputs 90 of the ROADM 80.

In the ROADM 80, the respective SOAs 84, 87 and 89 in each frequency channel 83 are used as switches by selectively turning their drive currents on or off. This allows control of whether each through channel signal is or is not fed through to the through channel output 88 and/or the respective drop channel output 90. Similarly, this allows control of whether or not the add channel signals are fed through to the through channel output 88. As described above; the structure of the ROADM 80 is known.

In addition, each SOA 84, 87 and 89 in each frequency channel 83 is provided with an APC system in accordance with the present invention, for example the first APC system of FIG. 6 or the second APC system of FIG. 8. This allows the output power of the signals on each frequency channel 83 to be equalized by appropriate selection of the desired level of the amplified signal in each APC system.

Furthermore, by arranging each APC system to output monitor signals 95, as described above, the APC systems may be used to monitor each frequency channel 83. This avoids the need for a separate channel monitor which would otherwise be needed if it was desired to monitor the signals on each frequency channel 83. Such a channel monitor would be very expensive to implement; so the ability to derive monitor signals 95 from the APC systems provides a significant cost-saving.

The above-described embodiments are not limitative of the invention. Numerous modifications of the embodiments and alternative ways of implementing the invention are envisaged. Possible modifications to the embodiments described above are as follows.

In the embodiments described above, the arrangement used to detect the output power of the SOA 10 is a tap-coupler 23 in combination with a photo diode 25, but other arrangements are possible. For example, where the signal path 20 on the output side of the SOA 10 includes an optical fiber, an evanescent-based fiber monitor may be used to detect the optical power. Such fiber monitors are in themselves conventional and comprise a photo-diode provided adjacent a portion of the fiber which is polished so that a controlled portion of the evanescent field is detected by the photo-diode. Another alternative is for an integrated monitor tap-coupler, in which the tap-coupler and the photo-diode are arranged in one package.

Alternative, a photodetector may be integrated in the same package as the SOA 10, either monolithically in the same semiconductor chip as the SOA 10, or in a hybrid package in which the SOA and further components including the photodetector are integrated in the same package. Suitable arrangements of this type are disclosed in U.S. Pat. No. 5,040,033, U.S. Pat. No. 5,281,829, U.S. Pat. No. 5,349,598 and US-2001/0053260.

One important aspect of this is that use of the APC compensation system with an SOA arranged as a pre-amplifier enables the user to optimize the signal power level on a detector, such as a pin or an avalanche photo-diode (APD), whilst at the same time making sure that the operating power for the pin or APD, including the ASE output by the SOA, does not exceed a safe level. For this mode of use, it would be preferred that the photodetector is integrated or combined with the SOA, for example as in the documents referred to above. On the other hand, when the SOA is used as a line amplifier, it would be preferred to use a photodetector separate from the SOA 10, for example as in the embodiments described above.

Whilst the present invention is described primarily as being applicable to an SOA, in fact the present invention may be applied to any other type of optical amplifier which introduces ASE into the output signal, for example a fiber amplifier such as an erbium-doped fiber amplifier (EDFA).

We claim:

1. An automatic power control system for automatic power control of a semiconductor optical amplifier arranged to amplify a signal, the system comprising:
an optical power detector arranged to detect the output power of the semiconductor optical amplifier;
means for deriving a measure of the drive current of the semiconductor optical amplifier; and
an automatic power control loop arranged to provide automatic power control of the power of the amplified signal for maintaining the power of the amplified signal in the output from the semiconductor optical amplifier at a desired level using both the detected output power of the semiconductor optical amplifier and the derived measure of the drive, current.

2. An automatic power control system according to claim 1, wherein the automatic power control loop is arranged to compensate for an estimated level of amplified spontaneous emission in the output power of the semiconductor optical, amplifier.

3. An automatic power control system according to claim 2, wherein the automatic power control loop is arranged to compensate for an estimated level of amplified spontaneous emission in the output power of the semiconductor optical amplifier based on at least the derived measure of the drive current.

4. An automatic power control system according to claim 3, wherein the automatic power control loop is arranged to compensate for an estimated level of amplified spontaneous emission in the output power of the semiconductor optical amplifier based on the derived measure of the drive current and the detected output power.

5. An automatic power control system according to claim 3, wherein the automatic power control loop is arranged to compensate for an estimated level of amplified spontaneous emission in the output power of the semiconductor optical amplifier based on the derived measure of the drive current and the desired level of the amplified signal.

6. An automatic power control system according to claim 1, wherein the automatic power control loop further comprises memory means storing characteristics of the semiconductor optical amplifier, the automatic power control loop using the stored characteristics to compensate for the estimated level of amplified spontaneous emission in the output power of the semiconductor optical amplifier.

7. An automatic-power control system according to claim 6, wherein the memory means stores a look-up table of the characteristics.

8. An automatic power control system according to claim 6, wherein the memory means stores a numerical formula representing the characteristics.

9. An automatic power control system according to claim 1 wherein the automatic power control loop is arranged to derive an estimated level of the amplified signal from the detected output power, compensating for the level of amplified spontaneous emission in the output power of the semiconductor optical amplifier, and to provide said automatic power control using the estimated level of the amplified signal.

10. An automatic power control system according to claim 9, wherein the automatic power control loop is arranged to derive the error between the estimated level of the amplified signal and the desired level of the amplified signal, and to provide said automatic power control using said error.

11. An automatic power control system according to claim 1, wherein the automatic power control loop comprises:
an analog feedback loop arranged to perform power control of the semiconductor optical amplifier using the detected output power as a feedback signal to maintain the output power of the semiconductor optical amplifier at a selectable level; and
a controller: arranged to control said selectable level, compensating for an estimated level of amplified spontaneous emission using at least the derived measure of the drive current, so that the power of the amplified signal is maintained at the desired level by the analog feedback loop.

12. An automatic power control system according to claim 11, wherein the controller is arranged to implement a control algorithm comprising:
estimating the level of the amplified signal in the output power of the semiconductor optical amplifier using the derived measure of the drive current and a measure of the output power;
calculating the error between the estimated level of the amplified signal and the desired level; and
using said error to control said selectable level.

13. An automatic power control system according to claim 12, wherein said measure of the output power used in said step in said control algorithm of estimating the level of the amplified signal is said detected output power used by the analog feedback loop.

14. An automatic power control system according to claim 1, wherein the automatic power control loop comprises a digital controller arranged to provide said automatic power control of the semiconductor optical amplifier using both the detected output power and the derived measure of the drive current.

15. An automatic power control system according to claim 14, wherein the controller is arranged to implement a control algorithm comprising:
estimating the level of the amplified signal in the output power of the semiconductor optical amplifier using the detected output power and the derived measure of the drive current;
calculating the error between the estimated level of the amplified signal and the desired level; and
using said error to perform said power control.

16. An automatic power control system according to claim 15, wherein said step in said control algorithm of estimating the level of the amplified signal in the output power of the semiconductor optical amplifier comprises:
estimating the level of amplified spontaneous emission in the output power of said semiconductor optical amplifier; and
subtracting the estimated level of amplified spontaneous emission from the detected output power to derive the estimated level of the amplified signal in the output power of the semiconductor optical amplifier.

17. An automatic power control system according to claim 16, wherein said step in-said control algorithm of estimating the level of amplified spontaneous emission in the output power of said semiconductor optical amplifier is performed using the derived measure of the drive current and the desired level of the amplified signal.

18. An automatic power control system according to claim 1, wherein the optical power detector is a photodetector arranged to receive a portion of the output of the semiconductor optical amplifier.

19. An automatic power control system according to claim 1, wherein the means for deriving a measure of the drive current of the semiconductor optical amplifier is a current detector arranged to detect the drive current of the semiconductor optical amplifier.

20. An automatic power control system according to claim 1, wherein the automatic power control loop includes a current driver arranged to supply said drive current, the automatic power control loop being arranged to control the current driver to perform said power control.

21. An automatic power controller according to claim 20, wherein:
the automatic power control loop is arranged to control the current driver to perform said power control by way of supplying a control signal to the current driver representative of the drive current; and
the automatic power control loop is arranged to compensate for an estimated level of amplified spontaneous emission in the output power of the semiconductor optical amplifier using the detected output power and the control signal supplied to the current driver as the derived measure of the drive current.

22. An automatic power control system according to claim 1, wherein the controller further comprises means for outputting monitor signals representing at least one of:
the output power of the semiconductor optical amplifier;
the estimated level of the amplified signal; and
the estimated level of the amplified spontaneous emission in the output power of the semiconductor optical amplifier.

23. An automatic power control system for automatic power control of a semiconductor optical amplifier arranged to amplify a signal, the system comprising:
an optical power detector arranged to detect the output power of the semiconductor optical amplifier; and
an automatic power control loop arranged to provide automatic power control of the power of the amplified signal for maintaining the power of the amplified signal in the output from the semiconductor optical amplifier at a variable, desired level using the detected output power of the semiconductor optical amplifier, wherein the automatic power control loop is arranged to compensate for an estimated level of amplified spontaneous emission in the output power of the semiconductor optical amplifier based on at least two variables.

24. An automatic power control system according to claim 23, wherein the automatic power control loop is arranged to compensate for an estimated level of amplified spontaneous emission in the output power of the semiconductor optical amplifier based on the detected output power and the desired level of the amplified signal.

25. An automatic power controller according to claim 23, wherein
the automatic power control loop includes a current driver arranged to supply said drive current, the automatic power control loop being arranged to control the current driver to perform said power control by way of supplying a control signal to the current driver representative of the drive current; and
the automatic power control loop is arranged to compensate for an estimated level of amplified spontaneous emission in the output power of the semiconductor optical amplifier based on the detected output power and the control signal supplied to the current driver.

26. An automatic power control system according to claim 23, wherein the automatic power control loop further comprises memory means storing characteristics of the semiconductor optical amplifier, the automatic power control loop using the stored characteristics to compensate for the estimated level of amplified spontaneous emission in the output power of the semiconductor optical amplifier.

27. An automatic power control system according to claim 26, wherein the memory means stores a look-up table of the characteristics.

28. An automatic power control system according to claim 26, wherein the memory means stores a numerical formula representing the characteristics.

29. An automatic power control system according to claim 23, wherein the automatic power control loop is arranged to derive an estimated level of the amplified signal from the detected output power, compensating for the level of amplified spontaneous emission in the output power of the semiconductor optical amplifier, and to provide said automatic power control using the estimated level of the amplified signal.

30. An automatic power control system according to claim 29, wherein the automatic power control loop is arranged to derive the error between the estimated level of the amplified signal and the desired level of the amplified signal, and to provide said automatic power control using said error.

31. An automatic power control system according to claim 23, wherein the automatic power control loop comprises a digital controller arranged to provide said automatic power control of the semiconductor optical amplifier using both the detected output power and the desired level of the amplified signal.

32. An automatic power control system according to claim 31, wherein the automatic power control loop includes a current driver arranged to supply said drive current, the automatic power control loop being arranged to control the current driver to perform said power control by way of the digital controller supplying a control signal to the current driver representative of the drive current.

33. An automatic power control system according to claim 31, wherein the controller is arranged to implement a control algorithm comprising:
estimating the level of the amplified signal in the output power using the detected output power and one of a measure of the drive current or the desired level of the amplified signal; and
calculating the error between the estimated level of the amplified signal and the desired level of the amplified signal.

34. An automatic power controller according to claim 33, wherein
the automatic power control loop includes a current driver arranged to supply said drive current, the, automatic power control loop being arranged to control the current driver to perform said power control by way of the digital controller supplying a control signal to the current driver representative of the drive current; and
said step in said control algorithm of estimating the level of the amplified signal in the output power comprises using the control signal supplied to the current driver.

35. An automatic power control system according to claim 23, wherein the optical power detector is a photodetector arranged to receive a portion of the output of the semiconductor optical amplifier.

36. An automatic power control system according to claim 23, wherein the controller further comprises means for outputting monitor signals representing at least one of:
the output power of the semiconductor optical amplifier;
the estimated level of the amplified signal; or
the estimated level of the amplified spontaneous in the output power of the semiconductor optical amplifier.

37. A reconfigurable optical add-drop multiplexer for a plurality of frequency channels, comprising:
a demultiplexer arranged to demultiplex an input multiplexed through channel signal into a plurality of demultiplexed through channel signals in respective frequency channels;
a plurality of add channels for respective add channel signals in the respective frequency channels;
in respect of each frequency channel:
a through channel semiconductor optical amplifier arranged to amplify the demultiplexed through channel signal in the respective frequency channel,
an add channel semiconductor optical amplifier arranged to amplify the add channel signal in the respective frequency channel, and
a drop channel semiconductor optical amplifier arranged to amplify the demultiplexed through channel signal in the respective frequency channel;
a multiplexer arranged to multiplex into an output signal the outputs of the through channel semiconductor optical amplifier in respect of all the frequency channels together with the outputs of the add channel semiconductor optical amplifiers in respect of all the frequency channels; and
in respect of each semiconductor optical amplifier, an automatic power control system.

38. A method of performing automatic power control of a semiconductor optical amplifier, comprising:
detecting the output power of the semiconductor optical amplifier;
deriving a measure of the drive current to the semiconductor optical amplifier; and
performing power control of the semiconductor optical amplifier using the detected output power and the derived measure of the drive current.

39. A method of performing automatic power control of a semiconductor optical amplifier, comprising:
detecting the output power of the semiconductor optical amplifier;
performing power control of the semiconductor optical amplifier using the detected output power, compensating for the level of amplified spontaneous emission in the output power of the semiconductor optical amplifier.
